(19) United States
(12) Patent Application Publication
(10) Pub. No.: US 2017/0344607 A1
(43) Pub. Date: Nov. 30, 2017

(54) APPARATUS AND METHOD FOR CONTROLLING SKEW IN DISTRIBUTED ETL JOB

(71) Applicant: SAMSUNG SDS CO., LTD., Seoul (KR)

(72) Inventors: Seong-Hwan CHO, Seoul (KR); Yoon-Won KO, Seoul (KR)

(73) Assignee: SAMSUNG SDS CO., LTD., Seoul (KR)

(21) Appl. No.: 15/606,892

(22) Filed: May 26, 2017

(30) Foreign Application Priority Data
May 27, 2016 (KR) 10-2016-0065325

(51) Int. Cl. G06F 17/30

(52) U.S. Cl. CPC G06F 17/30486; G06F 17/30563

(57) ABSTRACT

Provided are an apparatus and method for controlling a skew in a distributed extract, transform, load (ETL) job. The apparatus includes a divider configured to divide original data and generate a plurality of partitions to be processed in a distributed manner by a plurality of ETL tasks, and a re-divider configured to identify a straggler among the plurality of partitions on the basis of sizes of the plurality of partitions and divide the straggler on the basis of the number of available containers.

### CROSS-REFERENCE TO RELATED APPLICATION

This application claims priority to and the benefit of Korean Patent Application No. 10-2016-0065325, filed on May 27, 2016, the disclosure of which is incorporated herein by reference in its entirety.

### BACKGROUND

### 1. Field

The present disclosure relates to a technology for controlling skew occurring in a distributed extract, transform, load (ETL) job.

### 2. Discussion of Related Art

ETL refers to a series of processes of extracting data from one storage, transforming the extracted data, and loading the transformed data into another storage, and is used to exchange a large amount of data between different systems.

Therefore, a size of data to be processed is determined in advance for an ETL job and varies from several bytes to several terabytes. Also, each job has an end time at which the job should be completed, and achieving the end time is a top-priority objective.

Every company has the knowledge to effectively process an ETL job. However, most of the knowledge is subordinate to business and corresponds to optimization or manual work based on query tuning or experience of users.

With the recent advent of methods (e.g., Hadoop) for automatic distributed processing, there have been many attempts to use such methods for ETL. However, due to characteristics of data of companies, there is necessarily skew, which makes it difficult to efficiently process an ETL job in a distributed manner.

Here, skew is an influence on a time required for an entire job when some distributed tasks are completed much later than most other tasks. Generally, there is data skew and processing time skew.

Data skew occurs because amounts of data input to tasks are not uniform. Reducer tasks have been taken into serious consideration to solve this problem in a general distributed processing job. This is because the amounts of data input to the reducer tasks may significantly vary according to a shuffle algorithm in a general distributed processing job, whereas a relatively uniform amount of data is input to a map task.

However, due to characteristics of an ETL job, no reducer task is used in most cases, and an amount of data input to a map task may not be uniform. Accordingly, a technology for preventing such data skew is necessary.

### SUMMARY

The present disclosure is directed to providing an apparatus and method for controlling skew in a distributed extract, transform, load (ETL) job.

According to an aspect of the present disclosure, there is provided an apparatus for controlling a skew in a distributed ETL job, the apparatus including: a divider configured to divide original data and generate a plurality of partitions to be processed in a distributed manner by a plurality of ETL tasks; and a re-divider configured to identify a straggler among the plurality of partitions based on sizes of the plurality of partitions and divide the straggler based on the number of available containers.

The re-divider is further configured to identify the straggler by counting data units included in each of the plurality of partitions, and identifying a partition having a data unit count that is greater than or equal to a reference value as the straggler.

The re-divider is further configured to identify the straggler by calculating one of a median and a mean of data unit counts of the plurality of partitions, and identifying a partition, among the plurality of partitions, having a data unit count differing from the one of the median and the mean by at least a reference value as the straggler.

The re-divider is further configured to divide the straggler in response to a number of containers for performing the plurality of ETL tasks for the plurality of partitions being smaller than a maximum number of the available containers.

The re-divider is further configured to, in response to a number of containers for performing the plurality of ETL tasks for the plurality of partitions being equal to a maximum number of the available containers, merge two partitions having smallest sizes among the plurality of partitions and divide the straggler.

The re-divider is further configured to merge the two partitions in response to a sum of the sizes of the two partitions being smaller than a size of the straggler.

The apparatus further comprises a merger configured to identify, among a first group of partitions not obtained by dividing the straggler and a second group of partitions obtained by dividing the straggler, a first partition having a first size that is smaller than a reference value, and generate a second partition having a second size that is greater than or equal to the reference value by merging the first partition with a third partition.

The merger is further configured to count data units included in each of the first group of partitions and in each of the second group of partitions, and identify a fourth partition having a data unit count smaller than the reference value.

The reference value is set so that a first time required to start up and shut down containers for performing the plurality of ETL tasks is less than or equal to a second time required to perform the plurality of ETL tasks in the containers.

According to another aspect of the present disclosure, there is provided a method of controlling a skew in a distributed ETL job, the method including: dividing original data and generating a plurality of partitions to be processed in a distributed manner by a plurality of ETL tasks; identifying a straggler among the plurality of partitions based on sizes of the plurality of partitions; and dividing the straggler based on the number of available containers.

The identifying the straggler comprises counting data units included in each of the plurality of partitions; and identifying a partition having a data unit count that is greater than or equal to a reference value as the straggler.

The identifying the straggler comprises calculating one of a median or and a mean of the counted numbers of pieces of data unit counts of the plurality of partitions; and identifying a partition, among the plurality of partitions, having a counted number of pieces of a data unit count differing from one of the median or and the mean by the at least a reference value or more among the plurality of partitions as the straggler.

The dividing the straggler comprises dividing the straggler in response to a number of containers for performing the plurality of ETL tasks for the plurality of partitions being smaller than a maximum number of the available containers.

The dividing the straggler further comprises merging two partitions having smallest sizes among the plurality of partitions in response to a number of containers for performing the plurality of ETL tasks for the plurality of partitions being equal to a maximum number of the available containers.

The merging the two partitions comprises merging the two partitions in response to a sum of the sizes of the two partitions being smaller than a size of the straggler.

The method further comprises: identifying, among a first group of partitions not obtained by dividing the straggler and a second group of partitions obtained by dividing the straggler, a first partition having a first size that is smaller than a reference value among partitions not obtained by dividing the straggler and partitions obtained by dividing the straggler; and generating a second partition having a second size that is greater than or equal to the reference value by merging the identified the first partition with another a third partition.

The identifying of the partition the first partition comprises: counting a number of pieces of data units included in each of the first group of partitions not obtained by dividing the straggler and the second group of partitions obtained by dividing the straggler; and identifying a fourth partition having a counted number of pieces of data that is a data unit count smaller than the reference value.

The reference value is set so that a first time required to start up and shut down containers for performing the plurality of ETL tasks is less than or equal to a second time required to perform the plurality of ETL tasks in the containers.

According to another aspect of the present disclosure, there is provided an apparatus for controlling a skew in a distributed ETL job, the apparatus including: a divider configured to divide original data and generate a plurality of partitions to be processed in a distributed manner by a plurality of ETL tasks; and a merger configured to identify, among the plurality of partitions, a first partition having a first size that is smaller than a first reference value, and generate a second partition having a second size that is greater than or equal to the first reference value by merging the first partition with a third partition to yield a merged partition.

The merger is further configured to count data units included in each of the plurality of partitions, and identify a fourth partition having a data unit count that is smaller than the first reference value.

The first reference value is set so that a first time required to start up and shut down containers for performing the plurality of ETL tasks for the plurality of partitions is less than or equal to a second time required to perform the plurality of ETL tasks in the containers.

The apparatus further comprises a re-divider configured to identify, among the merged partition and the plurality of partitions other than the merged partition, a straggler based on sizes of the merged partition and the plurality of partitions other than the merged partition, and divide the straggler based on a number of available containers.

The identifying the straggler comprises counting data units included in each of the merged partition and the plurality of partitions other than the merged partition, and identifying a fourth partition having a data unit count that is greater than or equal to a second reference value as the straggler.

The identifying the straggler comprises calculating one of a median and a mean of data unit counts of the merged partition and the plurality of partitions other than the merged partition, and identifying a fourth partition having a data unit count differing from the one of the median and the mean by at least a second reference value as the straggler.

The re-divider is further configured to divide the straggler in response to a number of containers for performing the plurality of ETL tasks for the merged partition and the plurality of partitions other than the merged partition being smaller than a maximum number of the available containers.

The re-divider is further configured to, in response to a number of containers for performing the plurality of ETL tasks for the merged partition and the plurality of partitions other than the merged partition being equal to a maximum number of the available containers, merge two partitions having smallest sizes among the plurality of partitions and divide the straggler.

The re-divider is further configured to merge the two partitions in response to a sum of the sizes of the two partitions being smaller than a size of the straggler.

According to another aspect of the present disclosure, there is provided a method of controlling a skew in a distributed ETL job, the method including: dividing original data and generating a plurality of partitions to be processed in a distributed manner by a plurality of ETL tasks; identifying, among the plurality of partitions, a first partition having a first size that is smaller than a first reference value among the plurality of partitions; and generating a second partition having a second size that is greater than or equal to the first reference value by merging the identified the first partition with another a third partition to yield a merged partition.

The identifying of the first partition comprises: counting a number of pieces of data units included in each of the plurality of partitions; and identifying a fourth partition having a counted number of pieces of a data unit count that is smaller than the first reference value.

The first reference value is set so that a first time required to start up and shut down containers for performing the plurality of ETL tasks for the plurality of partitions is less than or equal to a second time required to perform the plurality of ETL tasks in the containers.

The method further comprises: identifying, among the merged partition and the plurality of partitions other than the merged partition, a straggler among the merged partition and the plurality of partitions other than the merged partition based on sizes of the merged partition and the plurality of partitions other than the merged partition among the plurality of partitions; and dividing the straggler based on a number of available containers.

The identifying of the straggler comprises: counting a number of pieces of data units included in each of the merged partition and the plurality of partitions other than the merged partition; and identifying a fourth partition having a counted number of pieces of a data unit count that is greater than or equal to a second reference value as the straggler.

The identifying the straggler comprises calculating one of a median and a mean of data unit counts of the merged partition and the plurality of partitions other than the merged partition, and identifying a fourth partition having a data unit count differing from the one of the median and the mean by at least a second reference value as the straggler.

The dividing the straggler comprises dividing the straggler in response to a number of containers for performing the plurality of ETL tasks for the merged partition and the plurality of partitions other than the merged partition being smaller than a maximum number of the available containers.

The dividing the straggler comprises merging two partitions having smallest sizes among the plurality of partitions in response to a number of containers for performing the plurality of ETL tasks for the merged partition and the plurality of partitions other than the merged partition being equal to a maximum number of the available containers.

The dividing the straggler further comprises merging the two partitions in response to a sum of the sizes of the two partitions being smaller than a size of the straggler.

Solutions to the problems of the present disclosure are not limited to the solutions described above, and other solutions that are not mentioned above may be clearly understood by those of ordinary skill in the art to which the present disclosure pertains from the following descriptions and the appended drawings.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an apparatus for controlling skew in a distributed extract, transform, load (ETL) job according to an exemplary embodiment of the present disclosure;

FIGS. 2 to 5 are diagrams showing an example of straggler dividing performed by a re-divider shown in FIG. 1;

FIG. 6 is a block diagram of an apparatus for controlling skew according to an additional embodiment of the present disclosure;

FIGS. 7 and 8 are diagrams showing an example of partition merging performed by a merger shown in FIG. 6;

FIGS. 9 and 10 are diagrams showing another example of partition merging performed by the merger shown in FIG. 6;

FIG. 11 is a block diagram of an apparatus for controlling skew according to another exemplary embodiment of the present disclosure;

FIGS. 12 and 13 are diagrams showing an example of partition merging performed by a merger shown in FIG. 11;

FIGS. 14 and 15 are diagrams showing another example of partition merging performed by the merger shown in FIG. 11;

FIG. 16 is a block diagram of an apparatus for controlling skew according to an additional embodiment of the present disclosure;

FIGS. 17 to 20 are diagrams showing an example of straggler dividing performed by a re-divider shown in FIG. 16;

FIG. 21 is a flowchart of a method of controlling skew in a distributed ETL job according to an exemplary embodiment of the present disclosure;

FIG. 22 is a flowchart of a method of controlling skew in a distributed ETL job according to another exemplary embodiment of the present disclosure;

FIG. 23 is a flowchart of a method of controlling skew in a distributed ETL job according to another exemplary embodiment of the present disclosure;

FIG. 24 is a flowchart of a method of controlling skew in a distributed ETL job according to another exemplary embodiment of the present disclosure;

FIG. 25 is a block diagram illustrating a computing environment including a computing apparatus that is suitable for exemplary embodiments.

### DETAILED DESCRIPTION OF EXEMPLARY EMBODIMENTS

Hereinafter, exemplary embodiments of the present disclosure will be described in detail with reference to the appended drawings. The following description is provided to assist in a comprehensive understanding of a method, an apparatus, and/or a system disclosed herein. However, the description is exemplary only, and the present disclosure is not limited thereto.

In descriptions of exemplary embodiments of the present disclosure, a detailed description of well-known technology related to the present disclosure will be omitted if it would unnecessarily obscure the subject matter of the present disclosure. Further, the terms to be described below are defined in consideration of functions in the present disclosure and may vary depending on a user's or an operator's intention or practice. Accordingly, a definition of such terms may be made on the basis of the content throughout the specification. The terminology used in the detailed description is only provided to describe exemplary embodiments of the present disclosure and not for purposes of limitation. Unless the context clearly indicates otherwise, the singular forms include the plural forms. It should be understood that the terms “comprise” or “include,” when used herein, specify some features, numbers, steps, operations, elements, and/or combinations thereof and do not preclude the additional presence of one or more other features, numbers, steps, operations, elements, and/or combinations thereof.

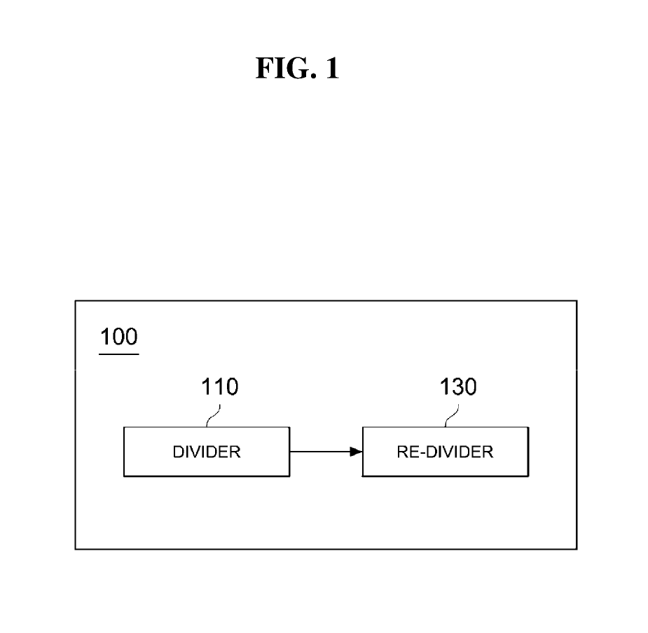

FIG. 1 is a block diagram of an apparatus 100 for controlling skew in a distributed extract, transform, load (ETL) job (referred to as a skew control apparatus below) according to an exemplary embodiment of the present disclosure.

Referring to FIG. 1, the skew control apparatus 100 according to an exemplary embodiment of the present disclosure includes a divider 110 and a re-divider 130.

The divider 110 divides original data and generates a plurality of partitions to be processed in a distributed manner by a plurality of ETL tasks.

Here, a partition denotes a data set to be processed by one ETL task. Also, an ETL task denotes one work unit that is processed in a distributed manner, and one ETL task performs an ETL job for one partition.

A partition and an ETL task are interpreted below as having the same meaning.

According to an exemplary embodiment of the present disclosure, the divider 110 may generate a plurality of partitions by dividing original data in units of time or files.

For example, when time values t1 and t2 are given, the divider 110 may extract all original data between t1 and t2 from an original storage, divide a time between the time values t1 and t2 into preset time periods, and generate a plurality of partitions by dividing the original data according to the preset time periods.

In another example, when a list of file paths or a path of a directory is given, the divider 110 may extract corresponding files or all files in the directory from an original storage and generate one partition from each of the files.

Meanwhile, the divider 110 may generate partitions in various ways other than the above-described example. For example, the divider 110 may use a sequence, which is a simple number, instead of time.

The re-divider 130 identifies a straggler among the plurality of partitions generated by the divider on the basis of sizes of the plurality of partitions and divides the identified straggler on the basis of the number of available containers.

Here, a container denotes a work process which performs a task, and is interpreted below as having this meaning.

Specifically, according to an exemplary embodiment of the present disclosure, the re-divider 130 may calculate a size of each partition by counting the number of pieces of data included in the partition generated by the divider 110. At this time, it is possible to use, for example, a count query of a relational database, a word count (wc) command of a file system, or the like for the counting.

According to an exemplary embodiment of the present disclosure, the re-divider 130 may identify a partition having a calculated size which is greater than or equal to a reference value among the plurality of partitions generated by the divider 110 as a straggler.

For example, the re-divider 130 may calculate a mean or a median of the counted numbers of pieces of data of the partitions. Also, the re-divider 130 may identify a partition having a counted number of pieces of data which differs from the median or the mean by the reference value or more as a straggler.

For example, the re-divider 130 may identify a partition satisfying Expression 1 below as a straggler.

c(pᵢ)>(Mean|Median)*(1+k), 0<i≦n, 0<k [Expression 1]

Here, Pᵢ denotes an i^{th} partition, c(Pᵢ) denotes the number of pieces of data in the i^{th} partition, n denotes the number of partitions, and k denotes a reference value.

The reference value k for identifying a straggler may be set to an appropriate value by a user.

According to an exemplary embodiment of the present disclosure, when a straggler is identified, the re-divider 130 may compare the number of containers for performing the ETL tasks for the plurality of partitions including the identified straggler with a maximum number of available containers and determine whether to divide the straggler. Here, the maximum number of available containers may be set by a user.

Specifically, according to an exemplary embodiment of the present disclosure, when the number of containers for performing the ETL tasks for the plurality of partitions including the straggler is smaller than the maximum number of available containers, the re-divider 130 may divide the identified straggler.

On the other hand, according to an exemplary embodiment of the present disclosure, when the number of containers for performing the ETL tasks for the plurality of partitions including the straggler is equal to the maximum number of available containers, the re-divider 130 may secure a container by merging two partitions having the smallest sizes among the plurality of partitions generated by the divider 110 and then divide the identified straggler.

At this time, according to an exemplary embodiment of the present disclosure, the re-divider 130 may compare a sum of the sizes of the two partitions with a size of the identified straggler. When the sum is smaller than the size of the identified straggler, the re-divider 130 may merge the two partitions having the smallest sizes and then divide the identified straggler.

On the other hand, when the sum of the sizes of the two partitions is greater than or equal to the size of the identified straggler, the re-divider 130 may complete division of the straggler.

In other words, in this case, even when containers for performing ETL tasks for partitions obtained by dividing the straggler are secured by merging the two partitions having the smallest sizes, a straggler having a larger size is generated, and thus the re-divider 130 may complete division of the identified straggler.

Meanwhile, the re-divider 130 may divide the identified straggler into two partitions having the same size. However, the present disclosure is not limited to this case, and division of the straggler may be modified in various ways according to exemplary embodiments.

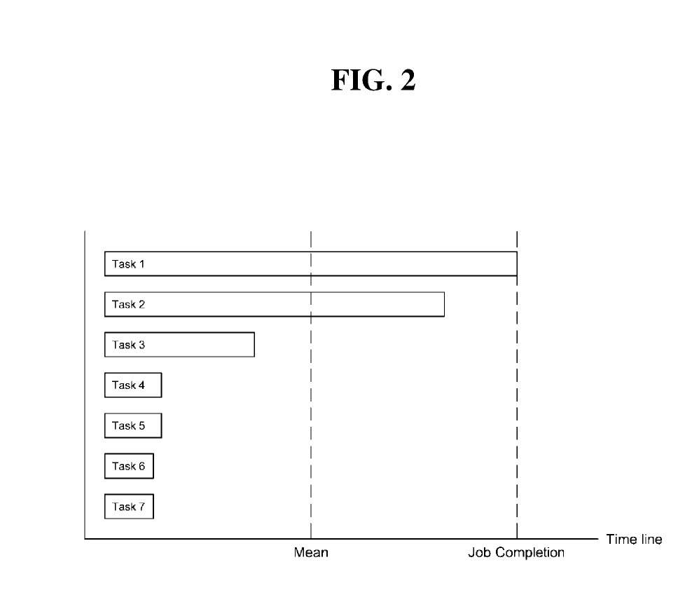

FIGS. 2 to 5 are diagrams showing an example of straggler dividing performed by the re-divider 130 shown in FIG. 1.

Specifically, FIG. 2 shows ETL tasks for processing partitions generated by the divider 110 in a distributed manner.

In the example shown in FIG. 2, it is assumed that a mean of the numbers of pieces of data in partitions assigned to tasks Task 1 to Task 7 is 250 and the reference value k is set to 0.5. Also, it is assumed that the number of pieces of data in the partition assigned to Task 1 is 600 and the number of pieces of data in the partition assigned to Task 2 is 550.

Since the number of pieces of data in the partition assigned to each of Task 1 and Task 2 (i.e., c(Pᵢ) and c(P₂)) satisfies the above-described Expression 1, the re-divider 130 may identify the partitions assigned to Task 1 and Task 2 as stragglers.

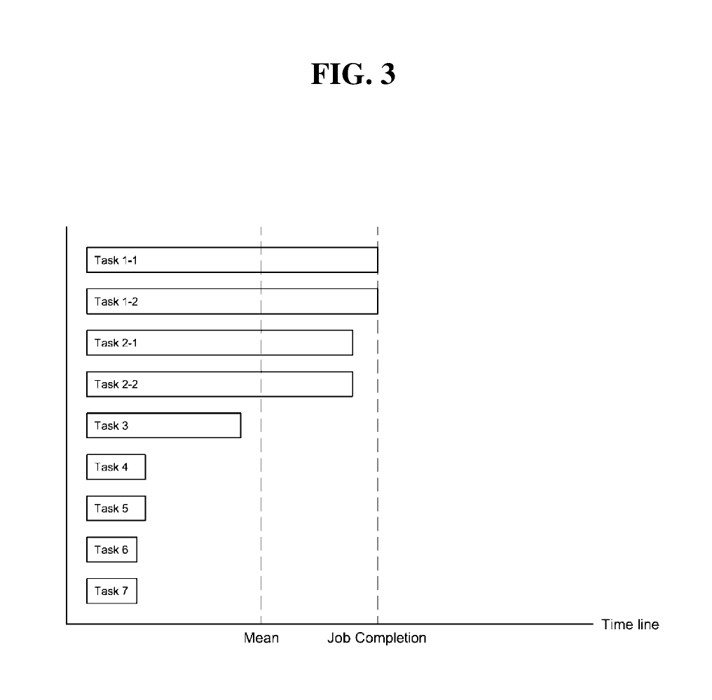

Here, the number of containers for performing the tasks Task 1 to Task 7 is seven. Therefore, when the maximum number of available containers is nine, the re-divider 130 divides the identified stragglers (i.e., the partitions assigned to Task 1 and Task 2) and assigns the divided stragglers to Task 1-1, Task 1-2, Task 2-1, and Task 2-2 as shown in the example of FIG. 3.

Meanwhile, unlike the example shown in FIG. 3, when the maximum number of available containers is seven, it is necessary to secure containers for performing tasks that process partitions obtained by dividing the stragglers in order to divide the identified stragglers (the partitions assigned to Task 1 and Task 2).

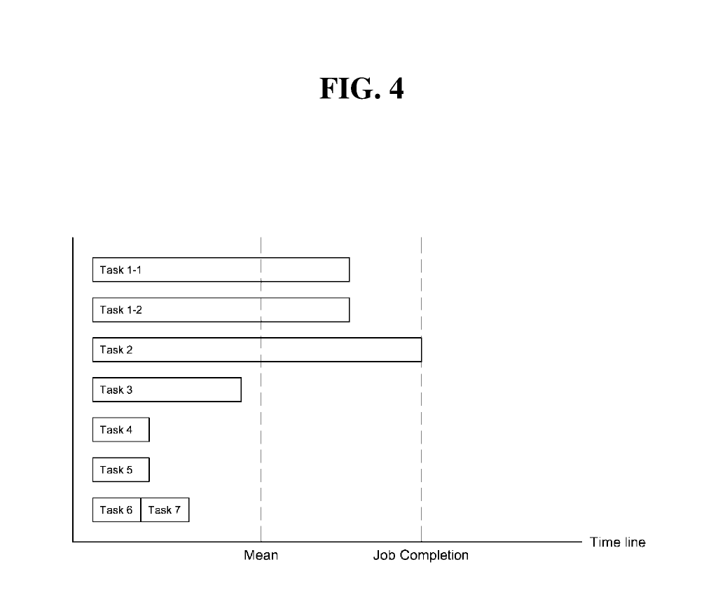

Therefore, in this case, the re-divider 130 may firstly merge two partitions having the smallest sizes (i.e., partitions assigned to Task 6 and Task 7) so that Task 6 and Task 7 are merged into one task as shown in the example of FIG. 4. Subsequently, the re-divider 130 may divide the partition assigned to Task 1 (i.e., a straggler) and assign the divided partitions to Task 1-1 and Task 1-2.

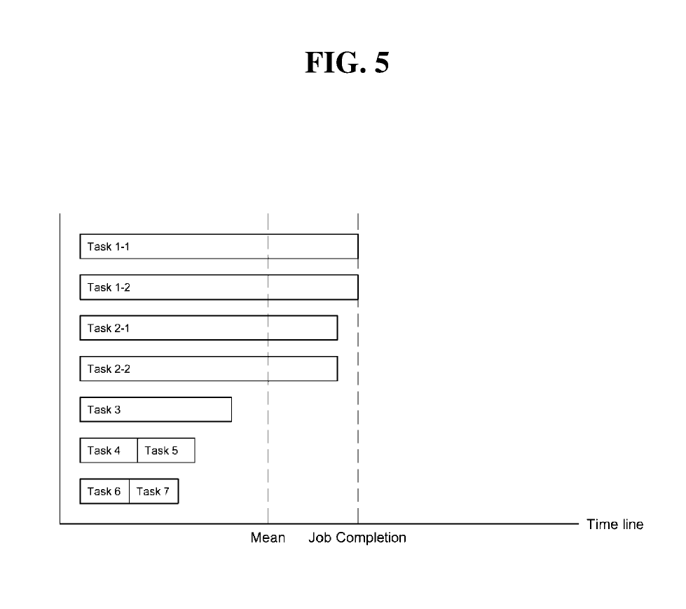

After that, the re-divider 130 may merge the two partitions having the smallest sizes (i.e., partitions assigned to Task 4 and Task 5) so that Task 4 and Task 5 are merged into one task as shown in the example of FIG. 5. Subsequently, the re-divider 130 may divide the partition assigned to Task 2 (i.e., a straggler) and assign the divided partitions to Task 2-1 and Task 2-2.

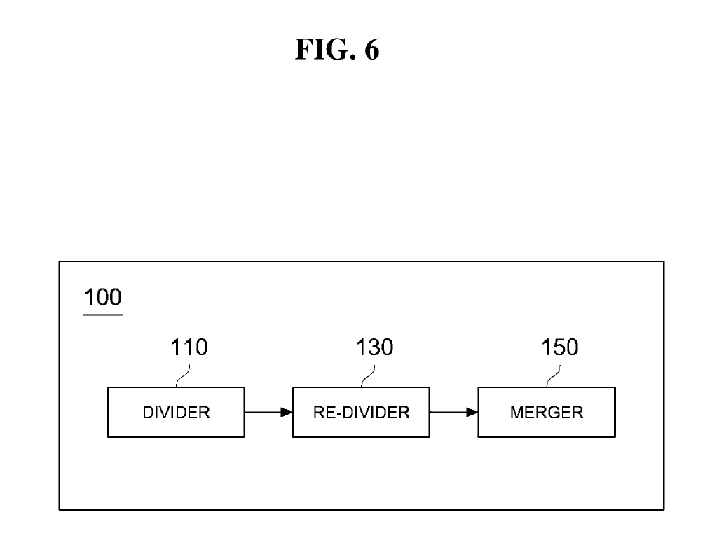

FIG. 6 is a block diagram of a skew control apparatus 100 according to an additional embodiment of the present disclosure.

Referring to FIG. 6, the skew control apparatus 100 according to the additional embodiment of the present disclosure includes a divider 110, a re-divider 130, and a merger 150.

Here, the divider 110 and the re-divider 130 are the same as the divider 110 and the re-divider 130 shown in FIG. 1, and detailed descriptions thereof will be omitted.

The merger 150 may merge some of partitions divided by the re-divider 130 (i.e., partitions obtained by dividing a straggler) and partitions not divided by the re-divider 130 (i.e., partitions not obtained by dividing a straggler). Here, the partitions not divided by the re-divider 130 may include partitions not divided by the re-divider 130 among partitions generated by the divider 110 and a partition merged by the re-divider 130.

Specifically, according to an exemplary embodiment of the present disclosure, after a straggler division process of the re-divider 130 is completed, the merger 150 may identify a partition having a size which is smaller than or equal to a reference value and generate a partition having a size which is greater than or equal to the reference value by merging the identified partition with another partition.

For example, the reference value may be set so that a time required to startup and shutdown containers for performing ETL tasks is less than or equal to a time required to actually perform the ETL tasks in the containers (i.e., a time during which partitions are processed by the ETL tasks).

For example, the reference value may be set to satisfy Expressions 2 and 3 below.

a+b<m*t [Expression 2]

a+b<d*T, 0<d<0.5 [Expression 3]

In Expressions 2 and 3, a denotes a time required for container startup, b denotes a time required for container shutdown, m denotes a reference value, and t denotes a processing time of a container per piece of data.

Also, in Expression 3, T denotes a total time required to perform an ETL task in a container (i.e., T=a+b+(n*t)).

Meanwhile, a, b, and t are system-dependent constants and may be measured in advance. For example, a, b, and t may be measured by performing an ETL job on sampled data in advance.

Also, d may be set to an appropriate value by a user according to a characteristic of a task.

Specifically, according to an exemplary embodiment of the present disclosure, the merger 150 may count the number of pieces of data included in each of partitions not obtained by dividing a straggler and partitions obtained by dividing a straggler and identify a partition having a counted number of pieces of data which is smaller than the reference value m.

At this time, it is possible to use, for example, a count query of a relational database, a we command of a file system, or the like for the counting.

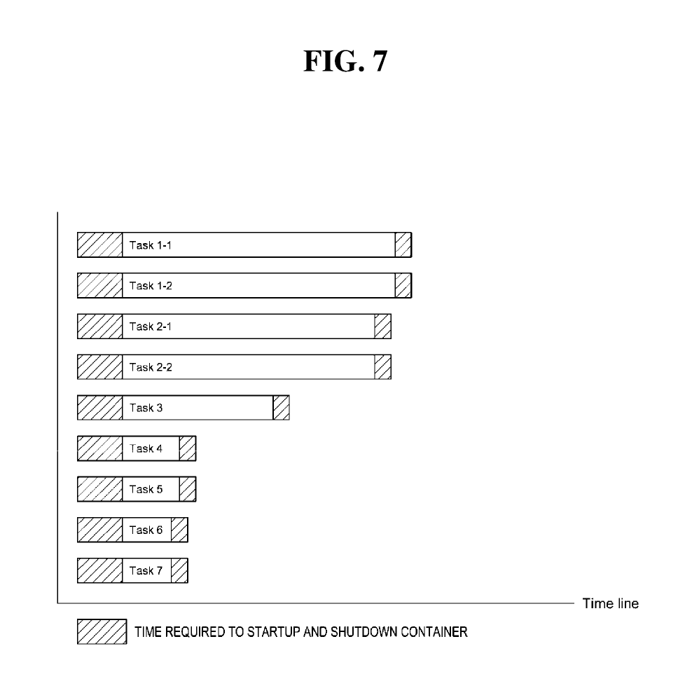

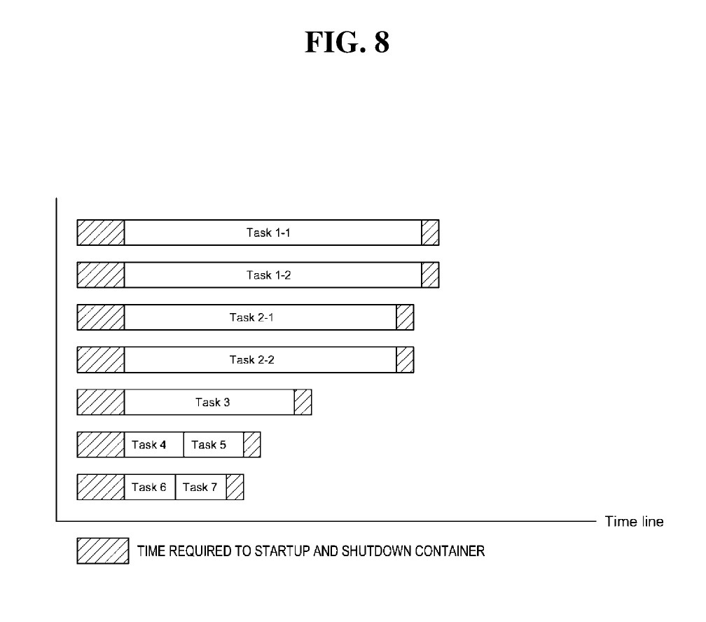

FIGS. 7 and 8 are diagrams showing an example of partition merging performed by the merger 150 shown in FIG. 6.

Specifically, in the example shown in FIGS. 7 and 8, black rectangles denote times required to startup and shutdown containers for performing the respective tasks.

In the example shown in FIG. 7, Task 1-1, Task 1-2, Task 2-1, and Task 2-2 denote ETL tasks that process partitions divided by the re-divider 130, and Task 3 to Task 7 denote ETL tasks that process partitions not divided by the re-divider 130.

In FIG. 7, assuming that Task 4 to Task 7 are ETL tasks assigned partitions having sizes which are smaller than the reference value m, the merger 150 may generate a partition having a size which is greater than the reference value m by merging the partitions assigned to Task 4 and Task 5 so that Task 4 and Task 5 are merged into one ETL task as shown in the example of FIG. 8.

Also, the merger 150 may generate a partition having a size which is greater than the reference value m by merging partitions assigned to Task 6 and Task 7 so that Task 6 and Task 7 are merged into one ETL task.

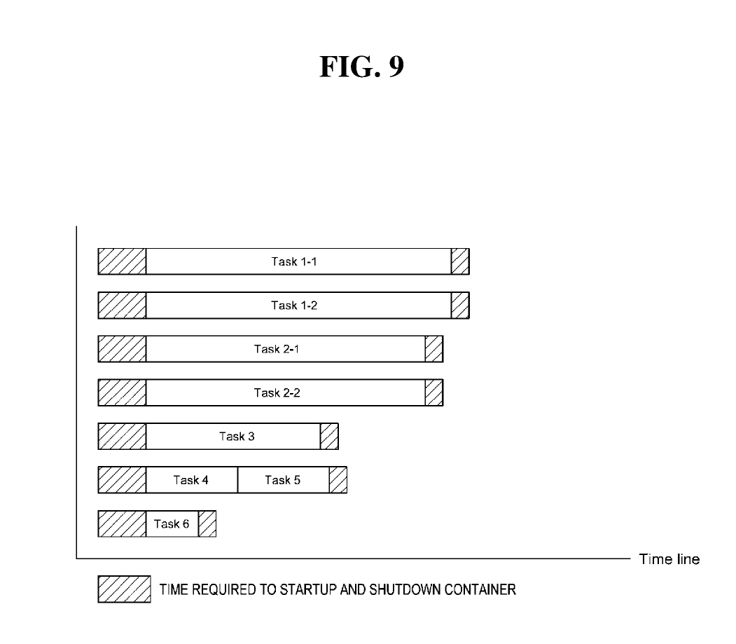

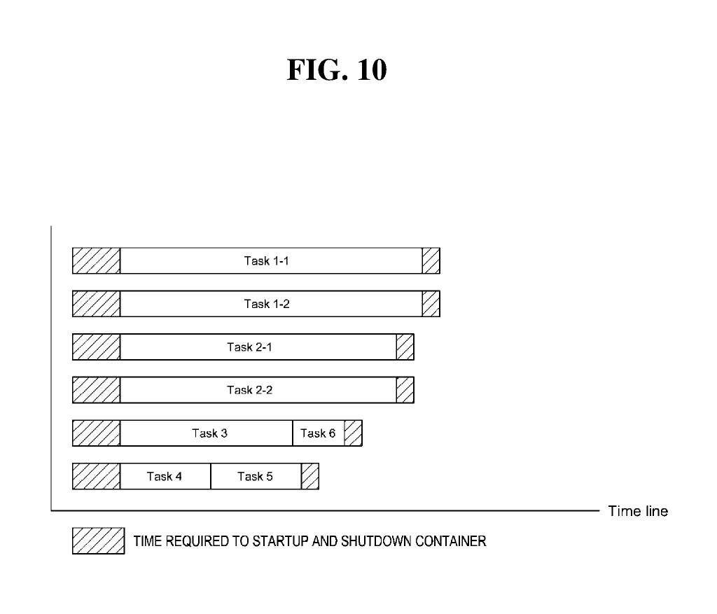

FIGS. 9 and 10 are diagrams showing another example of partition merging performed by the merger 150 shown in FIG. 6.

In the example shown in FIG. 9, Task 1-1, Task 1-2, Task 2-1, and Task 2-2 denote ETL tasks that process partitions divided by the re-divider 130, and Task 3 and Task 6 denote ETL tasks that process partitions not divided by the re-divider 130. Also, Task 4 and Task 5 denote ETL tasks that process a partition merged by the re-divider 130 to secure a container.

In FIG. 9, assuming that Task 6 is an ETL task assigned to a partition having a size which is smaller than the reference value m, the merger 150 may generate a partition having a size which is greater than the reference value m by merging the partition assigned to Task 6 with a partition having the smallest size (i.e. a partition assigned to Task 3) among the other partitions so that Task 3 and Task 6 are merged into one ETL task as shown in the example of FIG. 10.

Meanwhile, in an exemplary embodiment of the present disclosure, the divider 110, the re-divider 130, and the merger 150 may be implemented in a computing device including one or more processors and a computer-readable recording medium connected to the processors. The computer-readable recording medium may be present inside or outside the processors and may be connected to the processors by various well-known means. The processors present inside the computing device may allow the computing device to operate according to an exemplary embodiment described herein. For example, the processors may execute an instruction stored in the computer-readable recording medium, and the instruction stored in the computer-readable recording medium may be configured to allow the computing device to execute operations according to the exemplary embodiments described herein when executed by the processors.

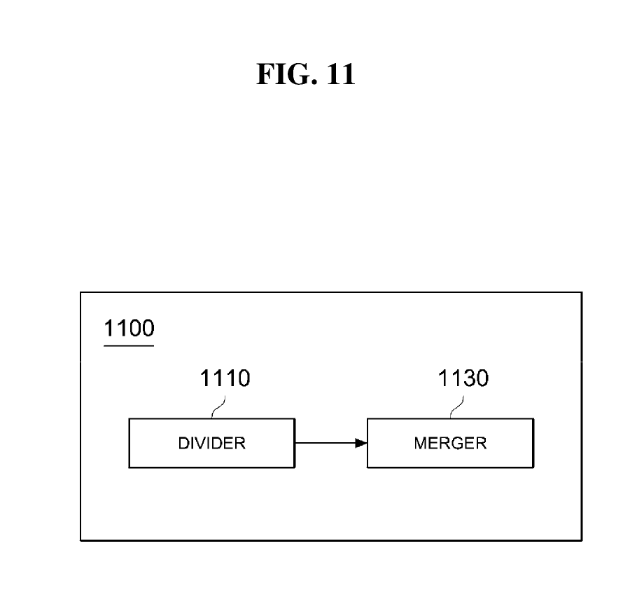

FIG. 11 is a block diagram of an apparatus for controlling skew according to another exemplary embodiment of the present disclosure.

Referring to FIG. 11, a skew control apparatus 1100 according to an exemplary embodiment of the present disclosure includes a divider 1110 and a merger 1130.

Here, the divider 1110 is the same as the divider 110 shown in FIG. 1, and detailed descriptions thereof will be omitted.

The merger 1130 may merge some partitions divided by the divider 1110.

Specifically, according to an exemplary embodiment of the present disclosure, the merger 1130 may identify a partition having a size which is smaller than or equal to a reference value m among the partitions divided by the divider 1110 and generate a partition having a size which is greater than or equal to the reference value m by merging the identified partition with another partition.

For example, the reference value m may be set so that so that a time required to startup and shutdown containers for performing ETL tasks is less than or equal to a time required to actually perform the ETL tasks in the container (i.e., a time during which partitions are processed by the ETL tasks).

For example, the reference value m may be set to satisfy the above-described Expressions 2 and 3.

Meanwhile, according to an exemplary embodiment of the present disclosure, the merger 150 may count the number of pieces of data included in each of the partitions generated by the divider 1110 and identify a partition having a counted number of pieces of data which is smaller than the reference value m.

At this time, it is possible to use, for example, a count query of a relational database, a we command of a file system, or the like for the counting.

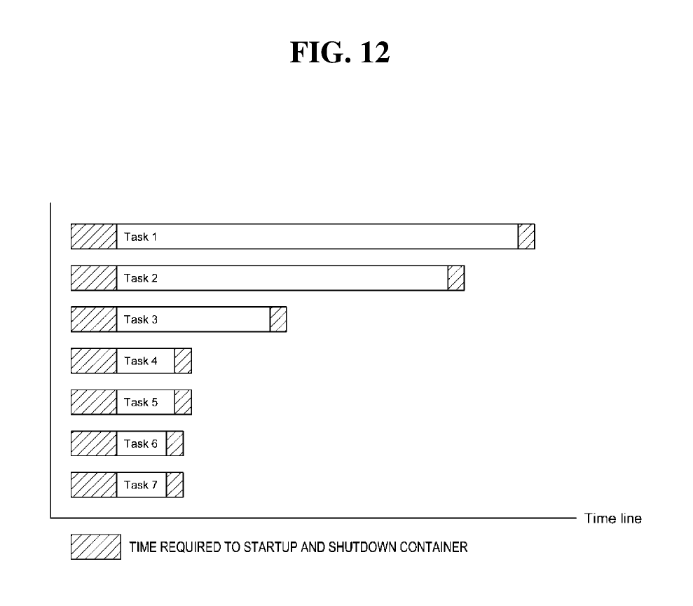

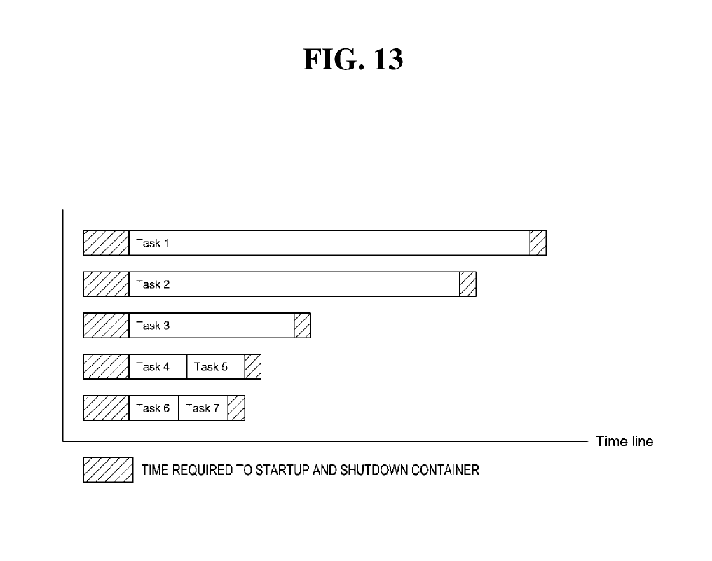

FIGS. 12 and 13 are diagrams showing an example of partition merging performed by the merger 1130 shown in FIG. 11.

In the example shown in FIG. 12, Task 1 to Task 7 denote ETL tasks that process partitions divided by the divider 1110.

In FIG. 12, assuming that Task 4 to Task 7 are ETL tasks assigned partitions having sizes which are smaller than the reference value m, the merger 1130 may generate a partition having a size which is greater than the reference value m by merging the partitions assigned to Task 4 and Task 5 so that Task 4 and Task 5 are merged into one ETL task as shown in the example of FIG. 13.

Also, the merger 1130 may generate a partition having a size which is greater than the reference value m by merging partitions assigned to Task 6 and Task 7 so that Task 6 and Task 7 are merged into one ETL task.

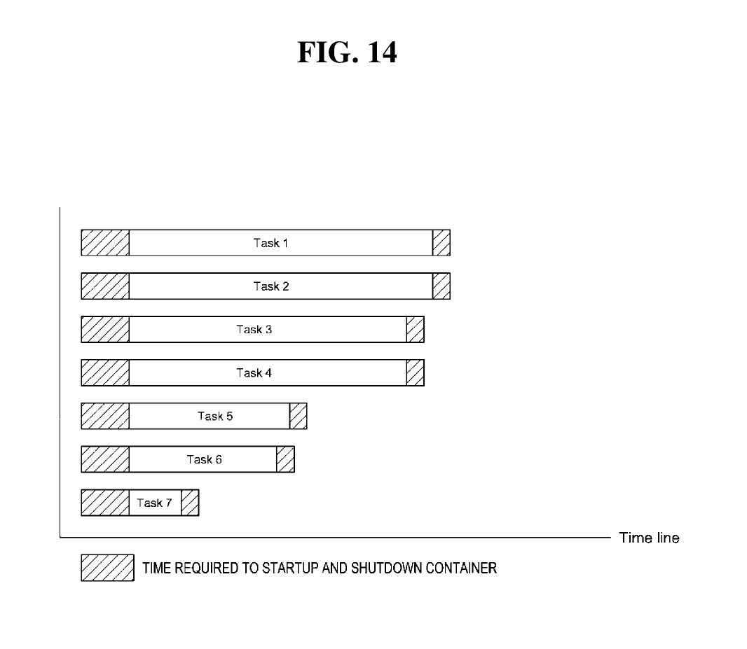

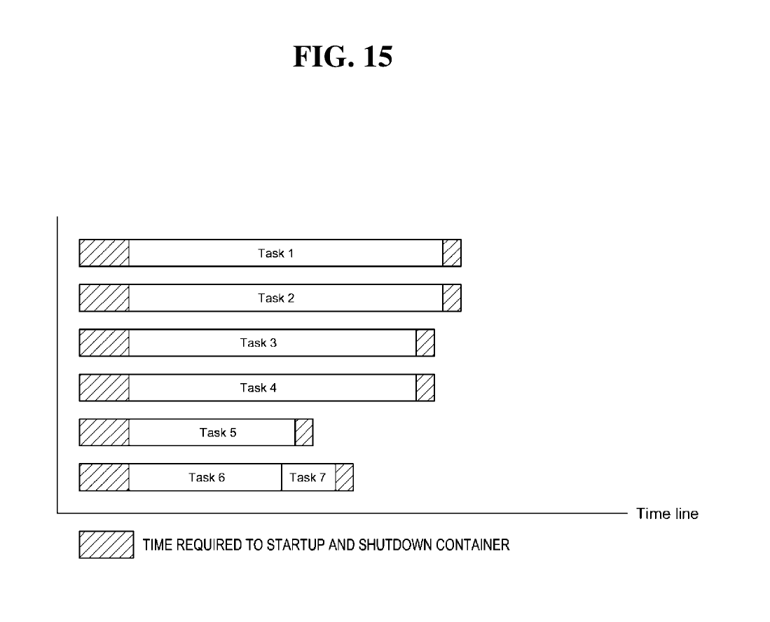

FIGS. 14 and 15 are diagrams showing another example of partition merging performed by the merger 1130 shown in FIG. 11.

In FIG. 14, assuming that Task 7 is an ETL task assigned a partition having a size which is smaller than the reference value m, the merger 1130 may generate a partition having a size which is greater than the reference value m by merging the partition assigned to Task 7 with a partition having the smallest size (i.e. a partition assigned to Task 6) among the other partitions so that Task 6 and Task 7 are merged into one ETL task as shown in the example of FIG. 15.

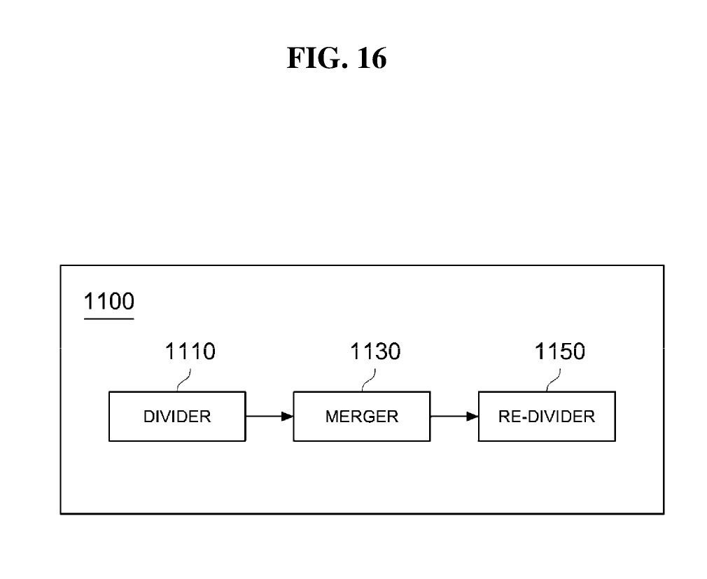

FIG. 16 is a block diagram of an apparatus for controlling skew according to an additional embodiment of the present disclosure.

Referring to FIG. 16, a skew control apparatus 1100 according to the additional embodiment of the present disclosure includes a divider 1110, a merger 1130, and a re-divider 1150.

In an example shown in FIG. 16, the divider 1110 and the merger 1130 are the same as the divider 1110 and the merger 1130 shown in FIG. 11, and detailed descriptions thereof will be omitted.

The re-divider 1150 may identify a straggler on the basis of sizes of a partition merged by the merger 1130 and partitions not merged by the merger 1130 and divide the identified straggler on the basis of the number of available containers.

Specifically, according to an exemplary embodiment of the present disclosure, the rre-divider 1150 may count the number of pieces of data included in each of the partition merged by the merger 1130 and the partitions not merged by the merger 1130 and calculate a size of each partition. At this time, it is possible to use, for example, a count query of a relational database, a we command of a file system, or the like for the counting.

According to an exemplary embodiment of the present disclosure, the re-divider 1150 may identify a partition having a calculated size which is greater than or equal to a reference value k.

For example, the re-divider 1150 may identify a partition satisfying the above-described Expression 1 as a straggler.

Meanwhile, according to an exemplary embodiment of the present disclosure, when a straggler is identified, the re-divider 1150 may compare the number of containers for performing ETL tasks for the plurality of partitions including the straggler with a maximum number of available containers and determine whether to divide the straggler. Here, the maximum number of available containers may be set by a user.

Specifically, according to an exemplary embodiment of the present disclosure, when the number of containers for performing the ETL tasks for the plurality of partitions including the straggler is smaller than the maximum number of available containers, the re-divider 1150 may divide the identified straggler.

On the other hand, according to an exemplary embodiment of the present disclosure, when the number of containers for performing the ETL tasks for the plurality of partitions including the straggler is equal to the maximum number of available containers, the re-divider 1150 may securing a container by merging two partitions having the smallest sizes and then divide the identified straggler.

At this time, according to an exemplary embodiment of the present disclosure, the re-divider 1150 may compare the sum of the sizes of the two partitions with a size of the identified straggler. When the sum is smaller than the size of the identified straggler, the re-divider 1150 may merge the two partitions having the smallest sizes and then divide the identified straggler.

On the other hand, when the sum of the sizes of the two partitions is greater than or equal to the size of the identified straggler, the re-divider 1150 may complete the division of the straggler without merging the two partitions.

Meanwhile, the re-divider 1150 may divide the identified straggler into two partitions having the same size. However, the present disclosure is not limited to this case, and the division of the straggler may be modified in various ways according to exemplary embodiments.

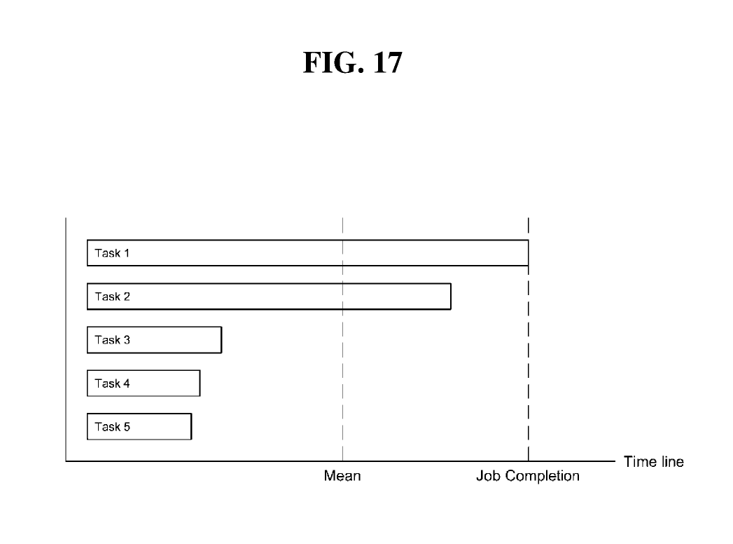

FIGS. 17 to 20 are diagrams showing an example of straggler dividing performed by the re-divider 1150 shown in FIG. 16.

In FIG. 17, Task 1 to Task 3 denote ETL tasks that process partitions not merged by the merger 1130, and Task 4 and Task 5 denote ETL tasks that process partitions merged by the merger 1130.

Specifically, in the example shown in FIG. 17, it is assumed that a mean of the numbers of pieces of data in partitions assigned to tasks is 250 and the reference value k is set to 0.5. Also, it is assumed that the number of pieces of data in a partition assigned to Task 1 is 600 and the number of pieces of data in a partition assigned to Task 2 is 550.

Since the number of pieces of data in the partition assigned to each of Task 1 and Task 2 (i.e., c(Pᵢ) and c(P₂)) satisfies Expression 1, the re-divider 1150 may identify the partitions assigned to Task 1 and Task 2 as stragglers.

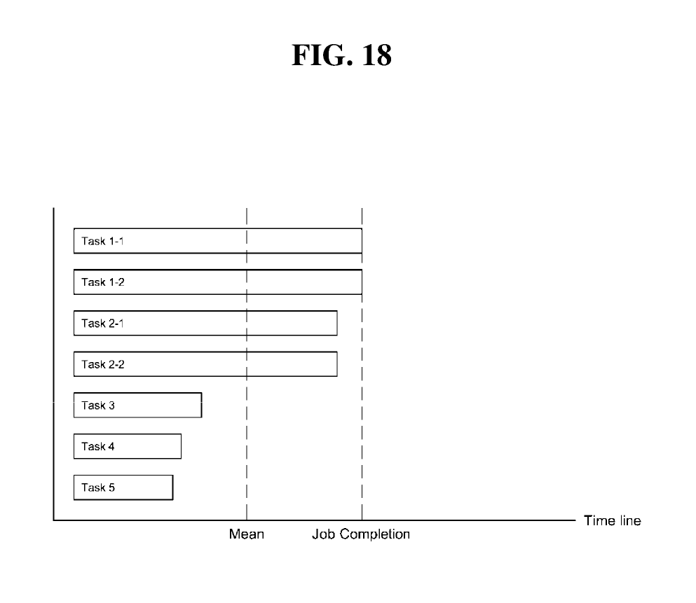

Here, the number of containers for performing the respective tasks is five. Therefore, when the maximum number of available containers is seven, the re-divider 1150 divides the identified stragglers (i.e., the partitions assigned to Task 1 and Task 2) and assign the divided stragglers to Task 1-1, Task 1-2, Task 2-1, and Task 2-2 as shown in the example of FIG. 18.

Meanwhile, unlike the example shown in FIG. 18, when the maximum number of available containers is five, it is necessary to secure containers for performing tasks that process partitions obtained by dividing the stragglers so that the identified stragglers (the partitions assigned to Task 1 and Task 2) are divided.

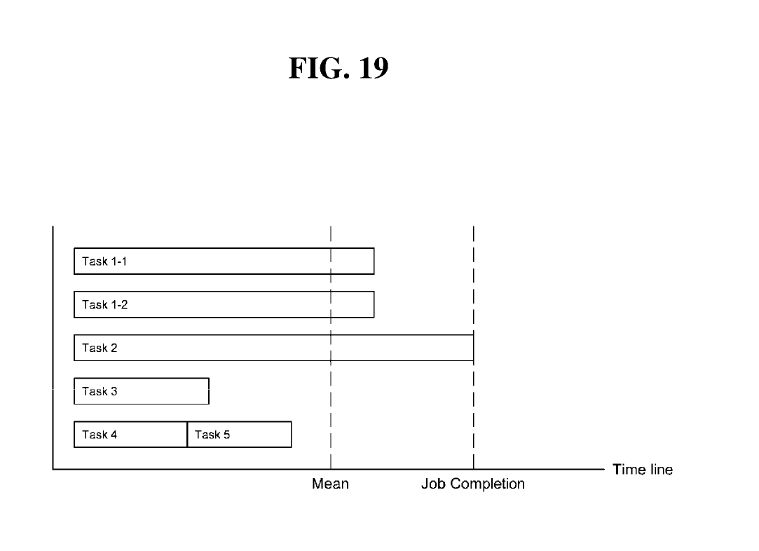

Therefore, in this case, the re-divider 1150 may merge two partitions having the smallest sizes (i.e., partitions assigned to Task 4 and Task 5) so that Task 4 and Task 5 are merged into one task as shown in the example of FIG. 19. Subsequently, the re-divider 1150 may divide the partition assigned to Task 1 (i.e., a straggler) and assign the divided partitions to Task 1-1 and Task 1-2.

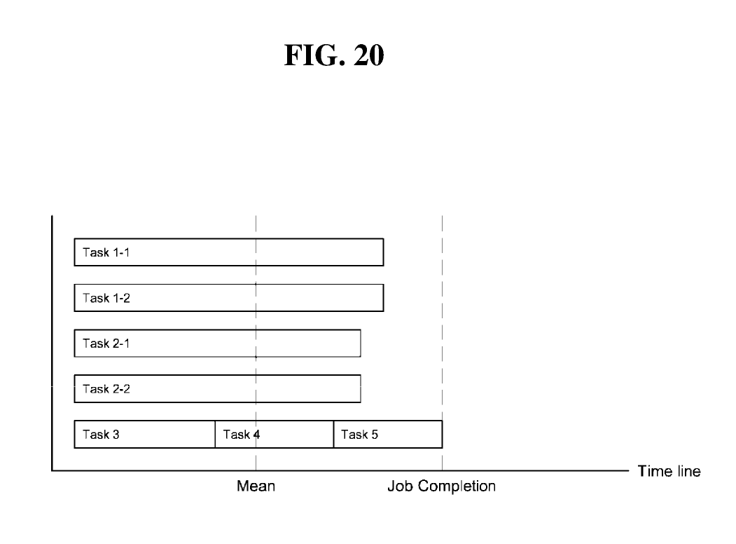

After that, the re-divider 1150 may merge the two partitions having the smallest sizes (i.e., the partition merged in FIG. 19 and a partition assigned to Task 3) so that Task 3 and the task merged in FIG. 19 are merged into one task as shown in the example of FIG. 20. Subsequently, the re-divider 1150 may divide the partition assigned to Task 2 (i.e., a straggler) and assign the divided partitions to Task 2-1 and Task 2-2.

Meanwhile, in an exemplary embodiment of the present disclosure, the divider 1110, the merger 1130, and the re-divider 1150 may be implemented in a computing device including one or more processors and a computer-readable recording medium connected to the processors. The computer-readable recording medium may be present inside or outside the processors and may be connected to the processors by various well-known means. The processors present inside the computing device may allow the computing device to operate according to an exemplary embodiment described herein. For example, the processors may execute an instruction stored in the computer-readable recording medium, and the instruction stored in the computer-readable recording medium may be configured to allow the computing device to execute operations according to the exemplary embodiments described herein when executed by the processors.

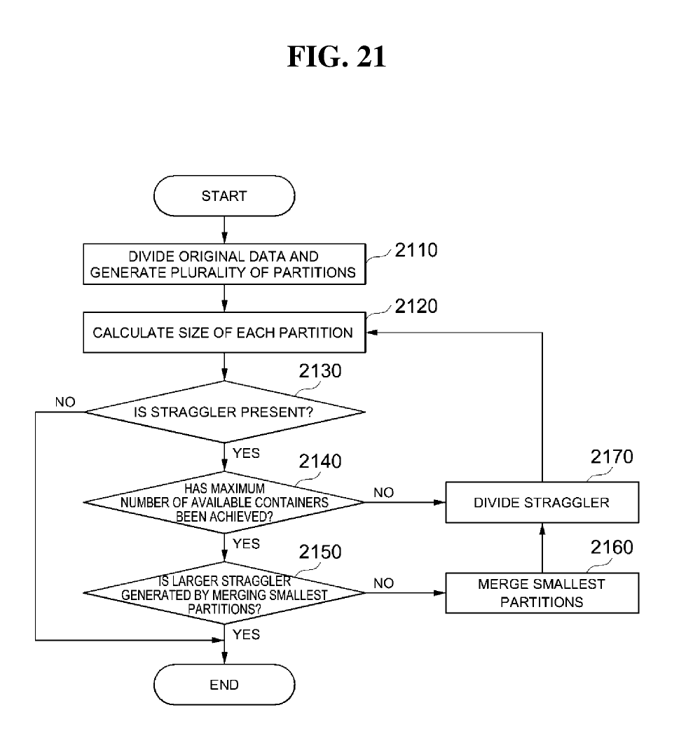

FIG. 21 is a flowchart of a method of controlling skew in a distributed ETL job according to an exemplary embodiment of the present disclosure.

The method illustrated in FIG. 21 may be performed by, for example, the skew control apparatus 100 shown in FIG. 1.

Referring to FIG. 21, the skew control apparatus 100 divides original data and generates a plurality of partitions to be processed in a distributed manner by a plurality of ETL tasks (2110).

Subsequently, the skew control apparatus 100 calculates a size of each partition (2120).

Subsequently, the skew control apparatus 100 determines whether a straggler is present among the plurality of partitions on the basis of the calculated size of each partition (2130).

At this time, according to an exemplary embodiment of the present disclosure, the skew control apparatus 100 may identify a partition having a size which is greater than or equal to the reference value k as a straggler.

When a straggler is present, the skew control apparatus 100 determines whether the number of containers for performing the ETL tasks for the plurality of partitions including the straggler is equal to a maximum number of available containers (2140).

When the number of containers is smaller than the maximum number of available containers, the skew control apparatus 100 divides the identified straggler (2170).

On the other hand, when the number of containers is equal to the maximum number of available containers, the skew control apparatus 100 determines whether the sum of sizes of two partitions having the smallest sizes is greater than or equal to a size of the identified straggler (2150).

When the sum is greater than or equal to the size of the identified straggler, the skew control apparatus 100 completes the division of the identified straggler.

On the other hand, when the sum is smaller than the size of the identified straggler, the skew control apparatus 100 merges the two partitions having the smallest sizes (2160) and divides the identified straggler (2170).

Subsequently, the skew control apparatus 100 may repeatedly perform operation 2120 to operation 2170. At this time, in operation 2120, only sizes of the partitions divided in operation 2170 or a size of a partition merged in operation 2160 may be calculated, and previously counted values may be used as sizes of the other partitions.

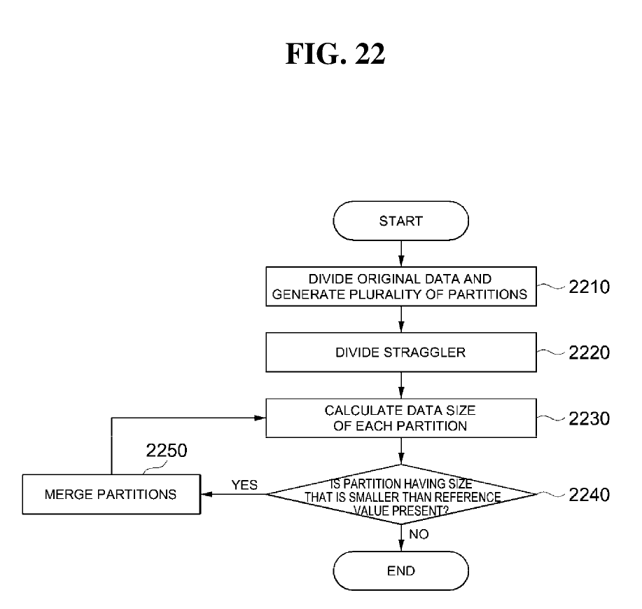

FIG. 22 is a flowchart of a method of controlling skew in a distributed ETL job according to another exemplary embodiment of the present disclosure.

The method illustrated in FIG. 22 may be performed by, for example, the skew control apparatus 100 shown in FIG. 6.

Referring to FIG. 22, the skew control apparatus 100 divides original data and generates a plurality of partitions to be processed in a distributed manner by a plurality of ETL tasks (2210).

Subsequently, the skew control apparatus 100 identifies a straggler among the plurality of generated partitions and divides the identified straggler (2220). Here, operation 2220 may be performed in the same way as, for example, operation 2120 to operation 2170 illustrated in FIG. 21.

Subsequently, the skew control apparatus 100 calculates a size of each partition (2230).

Subsequently, the skew control apparatus 100 determines whether a partition having a calculated size which is smaller than a reference value m is present (2240).

When there is a partition having a calculated size which is smaller than the reference value m, the skew control apparatus 100 generates a partition having a size which is greater than the reference value m by merging the partition having a size which is smaller than the reference value m with another partition (2250).

Subsequently, the skew control apparatus 100 repeatedly performs operation 2230 to operation 2250 until there is no partition having a size which is smaller than the reference value m. At this time, according to an exemplary embodiment, only sizes of partitions merged in operation 2240 may be calculated in operation 2230.

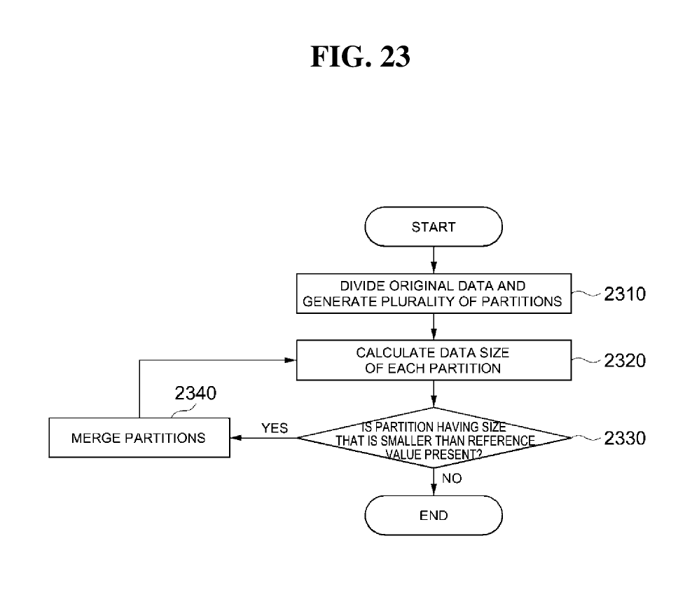

FIG. 23 is a flowchart of a method of controlling skew in a distributed ETL job according to still another exemplary embodiment of the present disclosure.

The method illustrated in FIG. 23 may be performed by, for example, the skew control apparatus 1100 shown in FIG. 11.

Referring to FIG. 23, the skew control apparatus 1100 divides original data and generates a plurality of partitions to be processed in a distributed manner by a plurality of ETL tasks (2310).

Subsequently, the skew control apparatus 1100 calculates a size of each partition (2320).

Subsequently, the skew control apparatus 1100 determines whether a partition having a calculated size which is smaller than a reference value m is present (2330).

When a partition having a calculated size which is smaller than the reference value m is present, the skew control apparatus 1100 generates a partition having a size which is greater than the reference value m by merging the partition having the size which is smaller than the reference value m with another partition (2340).

Subsequently, the skew control apparatus 1100 may repeatedly perform operation 2320 to operation 2340 until there are no partitions having a size which is smaller than the reference value m. According to an exemplary embodiment, in operation 2320, only sizes of the partitions merged in operation 2340 may be calculated, and previously counted values may be used as sizes of the other partitions.

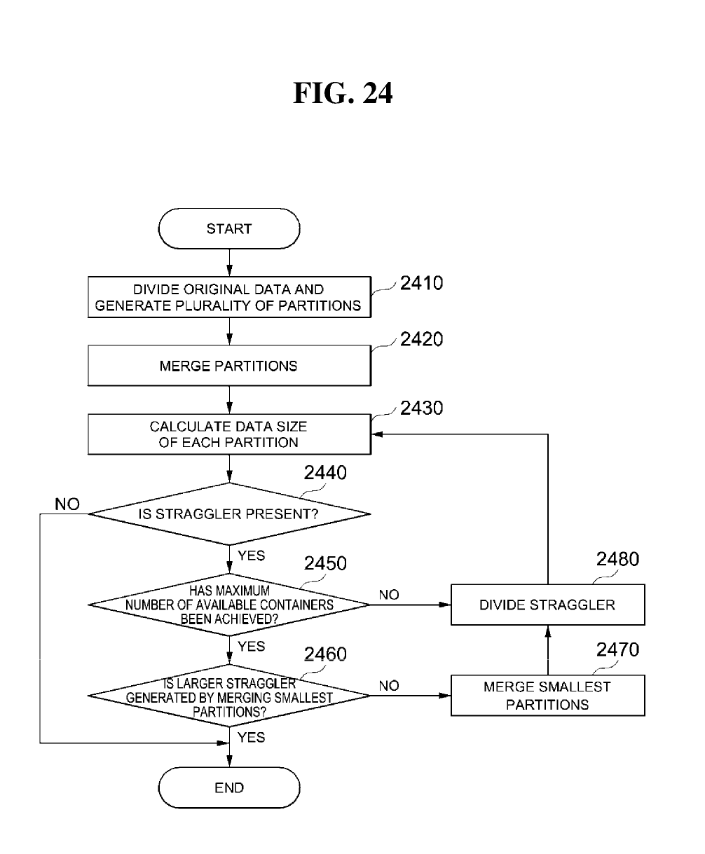

FIG. 24 is a flowchart of a method of controlling skew in a distributed ETL job according to yet another exemplary embodiment of the present disclosure.

The method illustrated in FIG. 24 may be performed by, for example, the skew control apparatus 1100 shown in FIG. 16.

Referring to FIG. 24, the skew control apparatus 1100 divides original data and generates a plurality of partitions to be processed in a distributed manner by a plurality of ETL tasks (2410).

Subsequently, the skew control apparatus 1100 identifies a partition having a size which is smaller than a reference value m among the plurality of generated partitions and generates a partition having a size which is greater than the reference value m by merging the partition having the size which is smaller than the reference value m with another partition (2420). Here, operation 2420 may be performed in the same way as, for example, operation 2320 to operation 2340 illustrated in FIG. 23.

Subsequently, the skew control apparatus 1100 calculates a size of each partition (2430).

Subsequently, the skew control apparatus 1100 determines whether a straggler is present on the basis of the calculated size of each partition (2440). According to an exemplary embodiment of the present disclosure, the skew control apparatus 100 may identify a partition having a size which is greater than or equal to the reference value k as a straggler.

When a straggler is present, the skew control apparatus 1100 determines whether the number of containers for performing the ETL tasks for the plurality of partitions including the straggler is equal to a maximum number of available containers (2450).

When the number of containers is smaller than the maximum number of available containers, the skew control apparatus 1100 divides the identified straggler (2480).

On the other hand, when the number of containers is equal to the maximum number of available containers, the skew control apparatus 1100 determines whether the sum of sizes of two partitions having the smallest sizes is greater than or equal to a size of the identified straggler (2460).

When the sum is greater than or equal to the size of the identified straggler, the skew control apparatus 1100 completes the division of the identified straggler.

On the other hand, when the sum is smaller than the size of the identified straggler, the skew control apparatus 1100 merges the two partitions having the smallest sizes (2470) and divides the identified straggler (2480).

Subsequently, the skew control apparatus 1100 may repeatedly perform operation 2430 to operation 2480. At this time, in operation 2430, only sizes of the partitions divided in operation 2480 or a size of a partition merged in operation 2470 may be calculated, and previously counted values may be used as sizes of the other partitions.

Meanwhile, although the methods are divided into a plurality of operations and illustrated in the flowcharts of FIGS. 20 to 24, at least some of the operations may be performed in a different order, performed in combination with another operation, omitted, subdivided, or performed together with one or more operations which are not illustrated therein.

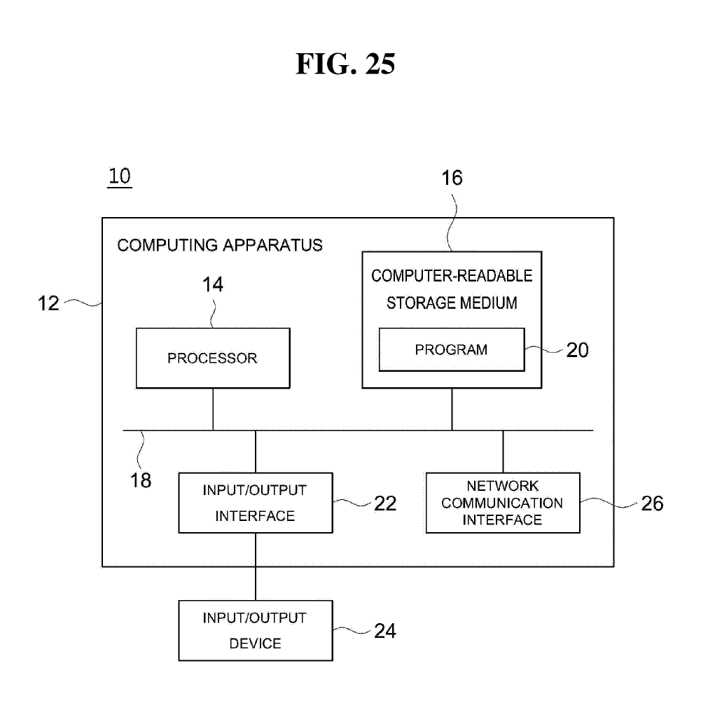

FIG. 25 is a block diagram illustrating a computing environment 10 including a computing apparatus that is suitable for exemplary embodiments. In the illustrated embodiment, each component may have a functionality and ability different from the following description, and may include additional components in addition to those in the following description.

The computing environment 10 includes a computing apparatus 12. According to an embodiment of the present disclosure, the computing apparatus 12 may be components constituting the skew control apparatus 100, for example, the divider 110, the re-divider 130, or the merger 150. According to another embodiment of the present disclosure, the computing apparatus 12 may be components constituting the skew control apparatus 1100, for example, the divider 1110, the merger 1130, or the re-divider 1150. The computing apparatus 12 includes at least one processor 14, a computer readable storage medium 16, and a communication bus 18. The processor 14 may allow the computing apparatus 12 to operate according to the above mentioned embodiment. For example, the processor 14 may execute one or more programs stored in the computer readable storage medium 16. The one or more programs may include one or more computer executable instructions, and the computer executable instruction may allow the computing apparatus 12 to perform operations according to the embodiments of the present disclosure when executed by the processor 14.

The computer readable storage medium 16 is configured to store computer executable instructions and program codes, program data, and/or other types of information. A program 20 stored in the computer readable storage medium 16 includes a set of instructions executable by the processor 14. According to an embodiment of the present disclosure, the computer readable storage medium 16 may be a memory (a volatile memory, such as a random access memory (RAM), a non-volatile memory, or an appropriate combination thereof), one or more magnetic disk storage devices, optical disk storage devices, flash memory devices, and other types of storage media that allow access of the computing apparatus 12 and are capable of storing desired information or appropriate combination thereof.

The communication bus 18 connects various components of the computing apparatus 12, including the processor 14 and the computer readable storage medium 16, to each other.

The computing apparatus 12 may include one or more input/output interfaces 22 to provide an interface for one or more input/output devices 24 and one or more network communication interfaces 26. The input/output interfaces 22 and the network communication interfaces 26 are connected to the communication bus 18. The input/output devices 24 may be connected to other components of the computing apparatus 12 through the input/output interfaces 22. Examples of the input/output device 24 may include a pointing device (a mouse or a track pad), a keyboard, a touch input device (a touch pad or a touch screen), a voice or sound input device, input devices, such as various types of sensor devices and/or photographing devices, and/or output devices, such as a display, a printer, a speaker, and/or a network card. The examples of the input/output device 24 may be included in the computing apparatus 12 as a component that constitutes the computing apparatus 12, or may be connected to the computing apparatus 12 as a separate device distinguished from the computing apparatus 12.

According to exemplary embodiments of the present disclosure, a straggler is identified on the basis of sizes of partitions divided for a distributed ETL job, and the identified straggler is subdivided and removed so that an end time of the entire ETL job may be significantly shortened.

Further, according to exemplary embodiments of the present disclosure, partitions divided for a distributed ETL job are merged on the basis of sizes thereof. For this reason, it is possible to reduce overhead that occurs because a time required to startup and shutdown containers for performing distributed ETL tasks is longer than a time required to actually perform the ETL tasks, and efficiency of the entire ETL job may be improved accordingly.

Although exemplary embodiments of the present disclosure have been described in detail above, those of ordinary skill in the art should appreciate that various modifications and variations are possible from the above description without departing from the scope of the present disclosure. Therefore, the scope of the present disclosure should be determined by the following claims and their equivalents, and is not limited or determined by the foregoing detailed description.

What is claimed is:

1. An apparatus for controlling a skew in a distributed extract, transform, load (ETL) job, the apparatus comprising:
a divider configured to divide original data and generate a plurality of partitions to be processed in a distributed manner by a plurality of ETL tasks; and
a re-divider configured to identify a straggler among the plurality of partitions based on sizes of the plurality of partitions, and divide the straggler based on a number of available containers.

2. The apparatus of claim 1, wherein the re-divider is further configured to identify the straggler by counting data units included in each of the plurality of partitions, and identifying a partition having a data unit count that is greater than or equal to a reference value as the straggler.

3. The apparatus of claim 1, wherein the re-divider is further configured to identify the straggler by calculating one of a median and a mean of data unit counts of the plurality of partitions, and identifying a partition, among the plurality of partitions, having a data unit count differing from the one of the median and the mean by at least a reference value as the straggler.

4. The apparatus of claim 1, wherein the re-divider is further configured to divide the straggler in response to a number of containers for performing the plurality of ETL tasks for the plurality of partitions being smaller than a maximum number of the available containers.

5. The apparatus of claim 1, wherein the re-divider is further configured to, in response to a number of containers for performing the plurality of ETL tasks for the plurality of partitions being equal to a maximum number of the available containers, merge two partitions having smallest sizes among the plurality of partitions and divide the straggler.

6. The apparatus of claim 5, wherein the re-divider is further configured to merge the two partitions in response to a sum of the sizes of the two partitions being smaller than a size of the straggler.

7. The apparatus of claim 1, further comprising a merger configured to identify, among a first group of partitions not obtained by dividing the straggler and a second group of partitions obtained by dividing the straggler, a first partition having a first size that is smaller than a reference value, and generate a second partition having a second size that is greater than or equal to the reference value by merging the first partition with a third partition.

8. The apparatus of claim 7, wherein the merger is further configured to count data units included in each of the first group of partitions and in each of the second group of partitions, and identify a fourth partition having a data unit count smaller than the reference value.

9. The apparatus of claim 7, wherein the reference value is set so that a first time required to start up and shut down containers for performing the plurality of ETL tasks is less than or equal to a second time required to perform the plurality of ETL tasks in the containers.

10. A method of controlling a skew in a distributed extract, transform, load (ETL) job, the method comprising:
dividing original data and generating a plurality of partitions to be processed in a distributed manner by a plurality of ETL tasks;
identifying a straggler among the plurality of partitions based on sizes of the plurality of partitions; and
dividing the straggler based on a number of available containers.

11. The method of claim 10, wherein the identifying the straggler comprises:
counting data units included in each of the plurality of partitions; and
identifying a partition having a data unit count that is greater than or equal to a reference value as the straggler.

12. The method of claim 10, wherein the identifying the straggler comprises:
calculating one of a median and a mean of data unit counts of the plurality of partitions; and
identifying a partition, among the plurality of partitions, having a data unit count differing from one of the median and the mean at least a reference value as the straggler.

13. The method of claim 10, wherein the dividing the straggler comprises dividing the straggler in response to a number of containers for performing the plurality of ETL tasks for the plurality of partitions being smaller than a maximum number of the available containers.

14. The method of claim 10, wherein the dividing the straggler further comprises merging two partitions having smallest sizes among the plurality of partitions in response to a number of containers for performing the plurality of ETL tasks for the plurality of partitions being equal to a maximum number of the available containers.

15. The method of claim 14, wherein the merging the two partitions comprises merging the two partitions in response to a sum of the sizes of the two partitions being smaller than a size of the straggler.

16. The method of claim 10, further comprising:
identifying, among a first group of partitions not obtained by dividing the straggler and a second group of partitions obtained by dividing the straggler, a first partition having a first size that is smaller than a reference value; and
generating a second partition having a second size that is greater than or equal to the reference value by merging the first partition with a third partition.

17. The method of claim 16, wherein the identifying the first partition comprises:
counting data units included in each of the first group of partitions and the second group of partitions; and
identifying a fourth partition having a data unit count smaller than the reference value.

18. The method of claim 16, wherein the reference value is set so that a first time required to start up and shut down containers for performing the plurality of ETL tasks is less than or equal to a second time required to perform the plurality of ETL tasks in the containers.

19. An apparatus for controlling a skew in a distributed extract, transform, load (ETL) job, the apparatus comprising:
a divider configured to divide original data and generate a plurality of partitions to be processed in a distributed manner by a plurality of ETL tasks; and
a merger configured to identify, among the plurality of partitions, a first partition having a first size that is smaller than a first reference value, and generate a second partition having a second size that is greater than or equal to the first reference value by merging the first partition with a third partition to yield a merged partition.

20. The apparatus of claim 19, wherein the merger is further configured to count data units included in each of the plurality of partitions, and identify a fourth partition having a data unit count that is smaller than the first reference value.

21. The apparatus of claim 19, wherein the first reference value is set so that a first time required to start up and shut down containers for performing the plurality of ETL tasks for the plurality of partitions is less than or equal to a second time required to perform the plurality of ETL tasks in the containers.

22. The apparatus of claim 19, further comprising a re-divider configured to identify, among the merged partition and the plurality of partitions other than the merged partition, a straggler based on sizes of the merged partition and the plurality of partitions other than the merged partition, and divide the straggler based on a number of available containers.

23. The apparatus of claim 22, wherein the identifying the straggler comprises counting data units included in each of the merged partition and the plurality of partitions other than the merged partition, and identifying a fourth partition having a data unit count that is greater than or equal to a second reference value as the straggler.

24. The apparatus of claim 22, wherein the identifying the straggler comprises calculating one of a median and a mean of data unit counts of the merged partition and the plurality of partitions other than the merged partition, and identifying a fourth partition having a data unit count differing from the one of the median and the mean by at least a second reference value as the straggler.

25. The apparatus of claim 22, wherein the re-divider is further configured to divide the straggler in response to a number of containers for performing the plurality of ETL tasks for the merged partition and the plurality of partitions other than the merged partition being smaller than a maximum number of the available containers.

26. The apparatus of claim 22, wherein the re-divider is further configured to, in response to a number of containers for performing the plurality of ETL tasks for the merged partition and the plurality of partitions other than the merged partition being equal to a maximum number of the available containers, merge two partitions having smallest sizes among the plurality of partitions and divide the straggler.

27. The apparatus of claim 26, wherein the re-divider is further configured to merge the two partitions in response to a sum of the sizes of the two partitions being smaller than a size of the straggler.

28. A method of controlling a skew in a distributed extract, transform, load (ETL) job, the method comprising:
dividing original data and generating a plurality of partitions to be processed in a distributed manner by a plurality of ETL tasks;
identifying, among the plurality of partitions, a first partition having a first size that is smaller than a first reference value; and
generating a second partition having a second size that is greater than or equal to the first reference value by merging the first partition with a third partition to yield a merged partition.

29. The method of claim 28, wherein the identifying the first partition comprises:
counting data units included in each of the plurality of partitions; and
identifying a fourth partition having a data unit count that is smaller than the first reference value.

30. The method of claim 28, wherein the first reference value is set so that a first time required to start up and shut down containers for performing the plurality of ETL tasks for the plurality of partitions is less than or equal to a second time required to perform the plurality of ETL tasks in the containers.

31. The method of claim 28, further comprising:
identifying, among the merged partition and the plurality of partitions other than the merged partition, a straggler based on sizes of the merged partition and the plurality of partitions other than the merged partition; and
dividing the straggler based on a number of available containers.

32. The method of claim 31, wherein the identifying the straggler comprises:
counting data units included in each of the merged partition and the plurality of partitions other than the merged partition; and
identifying a fourth partition having a data unit count that is greater than or equal to a second reference value as the straggler.

33. The method of claim 31, wherein the identifying the straggler comprises calculating one of a median and a mean of data unit counts of the merged partition and the plurality of partitions other than the merged partition, and identifying a fourth partition having a data unit count differing from the one of the median and the mean by at least a second reference value as the straggler.

34. The method of claim 31, wherein the dividing the straggler comprises dividing the straggler in response to a number of containers for performing the plurality of ETL tasks for the merged partition and the plurality of partitions other than the merged partition being smaller than a maximum number of the available containers.

35. The method of claim 31, wherein the dividing the straggler comprises merging two partitions having smallest sizes among the plurality of partitions in response to a number of containers for performing the plurality of ETL tasks for the merged partition and the plurality of partitions other than the merged partition being equal to a maximum number of the available containers.

36. The method of claim 35, wherein the dividing the straggler further comprises merging the two partitions in response to a sum of the sizes of the two partitions being smaller than a size of the straggler.
